(19) United States
(12) Patent Application Publication
(10) Pub. No.: US 2007/0183279 A1
(43) Pub. Date: Aug. 9, 2007

(54) APPARATUS FOR OPTICALLY RECORDING AND REPRODUCING INFORMATION

(75) Inventor: Koichiro NISHIKAWA, Takasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/623,497

(22) Filed: Jan. 16, 2007

(30) Foreign Application Priority Data
Feb. 3, 2006 (JP) 2006-027120

(51) Int. Cl. G11B 7/00

(52) U.S. Cl. 369/44.37; 369/44.23

(57) ABSTRACT

An apparatus for optically reproducing and recording information includes a light source, an objective lens, a light detecting element, and a processor. The objective lens focuses light beams emitted from the light source on an optical recording medium having tracks disposed at a track pitch. The wavelength of the light beams is greater than the track pitch of the medium. The light detecting element receives light beams reflected from the medium. The light detecting element includes a first region that receives substantially only light beams generated by interference between zeroth-order diffracted beams and first-order diffracted beams among the light beams reflected from the tracks of the medium and a second region that receives substantially only the zeroth-order diffracted beams. The processor generates focusing error signals using astigmatic focusing error detection on the basis of an output from the second region of the light detecting element.

### BACKGROUND OF THE INVENTION

1. Field of the Invention

The present invention relates to apparatuses for optically recording and reproducing information namely for recording information on optical recording media such as optical disks or for reproducing information recorded on optical recording media. In particular, the present invention relates to generating focusing error signals.

2. Description of the Related Art

Optical disk devices have been widely applied in various fields, and have been developed for use as recording devices for video recorders, video cameras, and the like.

When focusing attention on technologies for generating servo errors in optical pickup elements in the optical disk devices, astigmatic focusing error detection has been mainly used for generating focusing errors since the early days of compact disk devices.

In the astigmatic focusing error detection, as is generally known, astigmatism is introduced into a light detecting optical system prior to a split sensor using a cylindrical lens or the like. With this, the shape of a spot on the sensor is changed depending on the position (too close, in-focus, or too far) of an optical disk. Focusing error signals are obtained using outputs from split areas on the sensor.

At this time, when an object lens crosses tracks of the optical disk, interference is superposed on focusing signals by first-order diffracted beams reflected by the tracks composed of lands and grooves that are formed on the optical disk, resulting in fluctuations in the focusing signals. This causes unstable focusing servo control, actuator noise depending on the interference, and the like.

To solve this problem, Japanese Patent Laid-Open No. 10-097723 discloses a technology for reducing the interference caused by track crossing and for generating stable focusing error signals using a region on a sensor mainly receiving zeroth-order diffracted beams among light beams reflected from the tracks.

FIG. 10 illustrates a sensor 31 and a spot on the sensor used in the above-described technology.

The sensor 31 is sectioned into regions A, B, C, and D that mainly receive the zeroth-order diffracted beams among the light beams reflected from the tracks, and regions E and F that mainly receive light beams generated by the interference between the zeroth-order diffracted beams and the first-order diffracted beams.

The focusing error signals are obtained by calculating the following:

FE=(Sa+Sc)−(Sb+Sd)

where Sa, Sb, Sc, and Sd indicate outputs from the regions A, B, C, and D, respectively. Since only the regions A, B, C, and D, which mainly receive the zeroth-order diffracted beams, are used, stable focusing error signals can be obtained.

However, the areas where the zeroth-order diffracted beams and the first-order diffracted beams interfere with each other can be increased as shown in FIG. 10 depending on the relationship between the wavelength and the track pitch, and interference beams can also be incident on the regions A, B, C, and D. Therefore, fluctuations are introduced to the focusing error signals even when only the regions A, B, C, and D are used, thereby causing unstable focusing servo control and actuator noise.

To solve this problem, the regions on which mainly the zeroth-order diffracted beams are incident can be reduced such that the interference beams do not enter the regions. However, this leads to a reduction in the amount of the zeroth-order diffracted light used for generating the focusing error signals, and therefore, leads to unstable focusing error signals.

### SUMMARY OF THE INVENTION

According to the present invention, an area where zeroth-order diffracted beams and first-order diffracted beams interfere with each other is reduced, and at the same time, an area where only the zeroth-order diffracted beams lie is increased by increasing the wavelength of the light beams compared with the pitch of tracks of an optical recording medium. With this, crosstalk of components of track-crossing signals into focusing error signals generated by astigmatic focusing error detection can be reduced.

That is, according to one aspect of the present invention, an apparatus for optically reproducing and recording information includes a light source, an objective lens, a light detecting element, and a processor. The objective lens focuses light beams emitted from the light source on an optical recording medium having tracks disposed at a track pitch. The wavelength of the light beams emitted from the light source is greater than the track pitch of the optical recording medium. The light detecting element receives light beams reflected from the optical recording medium. The light detecting element includes a first region that receives substantially only light beams generated by interference between zeroth-order diffracted beams and first-order diffracted beams among the light beams reflected from the tracks of the optical recording medium and a second region that receives substantially only the zeroth-order diffracted beams. The processor generates focusing error signals using astigmatic focusing error detection on the basis of an output from the second region of the light detecting element.

According to another aspect of the present invention, an apparatus for optically reproducing and recording information includes a light source, an objective lens, a wavefront splitting element, a light detecting element, and a processor. The objective lens focuses light beams emitted from the light source on an optical recording medium having tracks disposed at a track pitch. The wavelength of the light beams emitted from the light source is greater than the track pitch of the optical recording medium. The wavefront splitting element splits light beams reflected from the optical recording medium. The wavefront splitting element includes a first region that receives mainly light beams generated by interference between zeroth-order diffracted beams and first-order diffracted beams among the light beams reflected from the tracks of the optical recording medium and a second region that receives substantially only the zeroth-order diffracted beams. The light detecting element receives light beams passing through the wavefront splitting element. The processor generates focusing error signals using astigmatic focusing error detection on the basis of an output from the light detecting element that receives the light beams passing through the second region of the wavefront splitting element.

According to yet another aspect of the present invention, an apparatus for optically reproducing and recording information includes a light source, focusing means, receiving means, and generating means. The focusing means focuses light beams emitted from the light source on an optical recording medium having tracks disposed at a track pitch. The wavelength of the light beams emitted from the light source is greater than the track pitch of the optical recording medium. The receiving means receives light beams reflected from the optical recording medium. The receiving means includes a first region for receiving substantially only light beams generated by interference between zeroth-order diffracted beams and first-order diffracted beams among the light beams reflected from the tracks of the optical recording medium and a second region for receiving substantially only the zeroth-order diffracted beams. The generating means generates focusing error signals using astigmatic focusing error detection on the basis of an output from the second region of said receiving means.

Further features of the present invention will become apparent from the following description of exemplary embodiments with reference to the attached drawings.

### BRIEF DESCRIPTION OF THE DRAWINGS

FIGS. 1A and 1B are schematic top and side views of an optical system according to a first exemplary embodiment of the present invention.

FIG. 2 is a schematic view illustrating diffraction by pregrooves according to the first exemplary embodiment of the present invention.

FIG. 3 is a schematic view of an intensity distribution on a surface of a pupil of an objective lens according to the first exemplary embodiment of the present invention.

FIG. 4 is a schematic view of a photodiode for generating RF signals and servo control signals according to the first exemplary embodiment of the present invention and a spot of light on the photodiode.

FIG. 5 illustrates relationships between disk shifts in a light axis direction and focusing errors at the moment according to the present invention and a known technology.

FIGS. 6A and 6B illustrate the relationships between the disk shifts in the light axis direction and the focusing errors at the moment according to the present invention and the known technology.

FIGS. 7A and 7B are schematic top and side views of an optical system according to a second exemplary embodiment of the present invention.

FIG. 8 is a schematic view of a diffractive element according to the second exemplary embodiment of the present invention.

FIGS. 9A and 9B are schematic views of light detecting portions according to the second exemplary embodiment of the present invention.

FIG. 10 is a schematic view of a light detecting element according to the known technology and a spot on the light detecting element.

### DESCRIPTION OF THE EMBODIMENTS

Exemplary embodiments of the present invention will now be described in detail with reference to the drawings.

### First Exemplary Embodiment

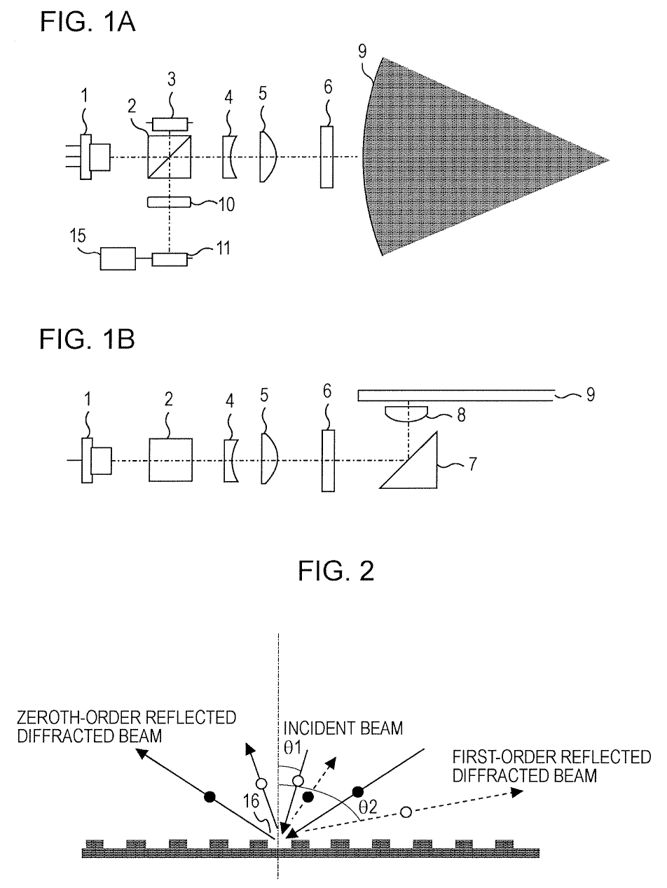

FIGS. 1A and 1B are schematic diagrams of an optical system of an apparatus for optically recording and reproducing information according to a first exemplary embodiment of the present invention.

First, the general outlines of the optical system will be described.

Light beams emitted from a semiconductor laser (LD) 1 are partly reflected from a polarizing beam splitter (PBS) 2, and are incident on a monitoring photodiode (PD) 3 for monitoring. Outputs from this monitoring PD 3 for monitoring are used for controlling the output power of the LD 1.

Light beams passing through the PBS 2 are incident on a collimating lens unit including a first lens 4 and a second lens 5, and become substantially parallel to each other. These parallel beams pass through a quarter-wave plate 6, are deflected by a mirror 7, and are focused on an optical disk 9 by an objective lens 8. During recording of information, light beams output from the LD 1 are modulated such that information is recorded on the optical disk 9. During reproduction of information, light beams are output from the LD 1 at a low power, and scan information tracks. Light beams reflected from the optical disk 9 are received by a photodiode (PD) 11 for generating radio-frequency (RF) signals and servo control signals. Information is reproduced on the basis of the received signals.

The collimating lens unit including the first lens 4 and the second lens 5 can impart variable spherical aberration to light beams that are focused on the optical disk 9 by changing the distance between the lenses in the unit, and thus can support dual-layer optical disks.

In this exemplary embodiment, the wavelength of the LD 1 is 405 nm, and the numerical aperture of the optical disk 9 is 0.85. The optical disk has pregrooves 16 of a pitch of 320 nm.

The light beams reflected from the optical disk 9 are incident on the PBS 2 via the objective lens 8, the quarter-wave plate 6, and the collimating lens unit including the first lens 4 and the second lens 5. These beams are reflected from the PBS 2, and focused on the PD 11 by a sensor lens 10. Information signals and signals for servo control are obtained from the output from the PD 11. Such signals can be provided to a processor 15 for signal processing as is known in the art.

The light beams focused by the objective lens 8 are reflected and diffracted by the pregrooves. The diffraction of the light beams will now be described.

First, a component of incident beams having an incident angle θ1 will be discussed.

When a first-order diffraction angle of reflected beams is defined as θ2, the following expression can be obtained from a relation between beams incident on a diffraction grating and beams diffracted from the diffraction grating:

sin θ2−sin θ1=405/320.

As a result, first-order diffracted beams can be obtained when the following condition is satisfied:

−58.2°<θ1<−15.4°

At this time, the first-order diffraction angle is in the following range:

24.6°<θ2<90°.

FIG. 2 is a schematic view illustrating the relationship between the incident beams and the reflected diffracted beams.

FIG. 2 illustrates two types of incident beams, reflected beams, and reflected diffracted beams indicated by filled circles and open circles.

In the drawing, when an angle perpendicular to the surfaces of the pregrooves 16 (indicated by an alternately long and short dashed line) is defined as 0°, the area expanding from 0° in the counterclockwise direction is defined as a positive area of the incident angle θ1, and the area expanding from 0° in the clockwise direction is defined as a positive area of the reflected diffracted angle θ2.

Therefore, in an area where the reflected diffracted angle is negative, the incident angle θ1 is within the following range:

15.4°<θ1<58.2°.

Herein, limits of ±58.2° are determined from the following expression using the numerical aperture of the objective lens when the light beams are incident on the objective lens:

sin θ1=0.85.

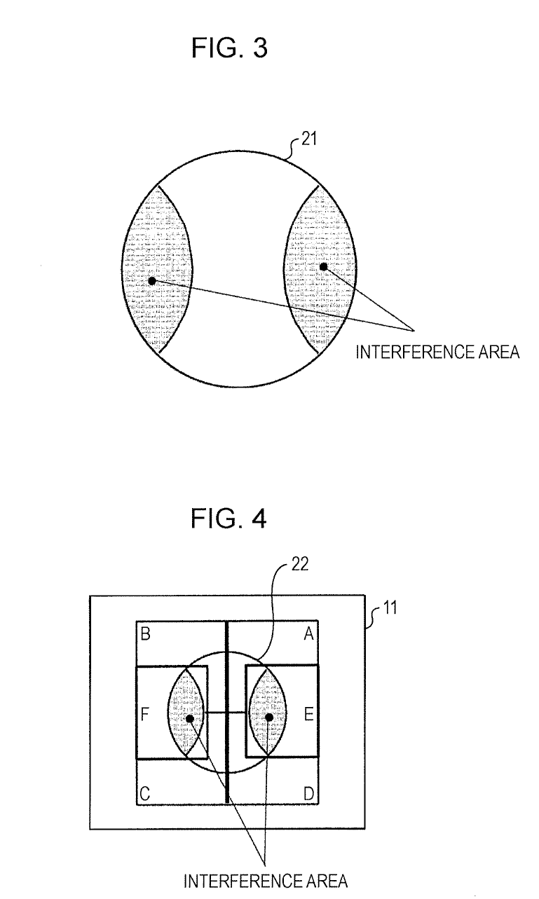

FIG. 3 is a schematic view of an intensity distribution 21 of reflected beams on a surface of a pupil at this time, the reflected beams entering the objective lens 8. That is, areas where zeroth-order diffracted beams and the first-order diffracted beams interfere with each other are not generated adjacent to the center, and are widely separated from each other. This is because the pitch of the pregrooves is smaller than the wavelength in use.

The present invention has been produced by focusing attention on this point. That is, the areas where the zeroth-order diffracted beams and the first-order diffracted beams interfere with each other can be located adjacent to the center depending on the relationship between the wavelength and the track pitch. This can cause difficulty in generating focusing error signals using the zeroth-order diffracted beams by astigmatic focusing error detection. In contrast, according to the present invention, the areas where the zeroth-order diffracted beams and the first-order diffracted beams interfere with each other are reduced, and at the same time, the area where only the zeroth-order diffracted beams lie is increased by increasing the wavelength of the light beams compared with the pitch of the tracks. With this, crosstalk of components of track-crossing signals into focusing error signals generated by astigmatic focusing error detection can be reduced.

In this exemplary embodiment, a surface of the sensor lens 10 adjacent to the PBS 2 has a cylindrical curvature, and the other surface adjacent to the PD 11 has a spherical curvature.

As in the known technology, a generating line of the cylindrical surface is rotated about a light axis so as to be inclined by 45° with respect to a track direction of the optical disk 9. The focusing error is generated using astigmatism caused by this cylindrical surface.

FIG. 4 is a schematic view of a light detecting area of the PD 11 and a spot 22 of received light.

The PD 11 is a sextant photodetector including six sectioned regions A, B, C, D, E, and F. The regions E and F are located so as to cover the interference areas in the spot 22. The size of the regions is set such that the interference areas do not protrude from the regions E and F even when an assembly error (on the order of an eighth of the radius of the spot 22) is introduced.

Moreover, the focusing error (FE) is obtained from the following:

FE=(Sa+Sc)−(Sb+Sd)

where Sa, Sb, Sc, and Sd indicate outputs from the regions A, B, C, and D, respectively. Furthermore, a tracking error (TE) is defined by the following expression such that a change in the interference areas can be obtained.

TE=Se−Sf

where Se and Sf indicate outputs from the regions E and F, respectively.

In this manner, according to this exemplary embodiment of the present invention, the change in the interference areas does not influence the generation of the focusing error.

Next, experimental results of this exemplary embodiment will be described.

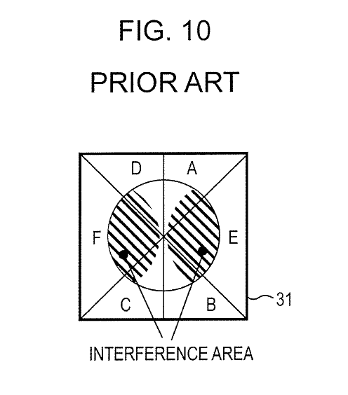

Focusing errors according to this exemplary embodiment are compared with those obtained using the quadrant photodetector shown in FIG. 10.

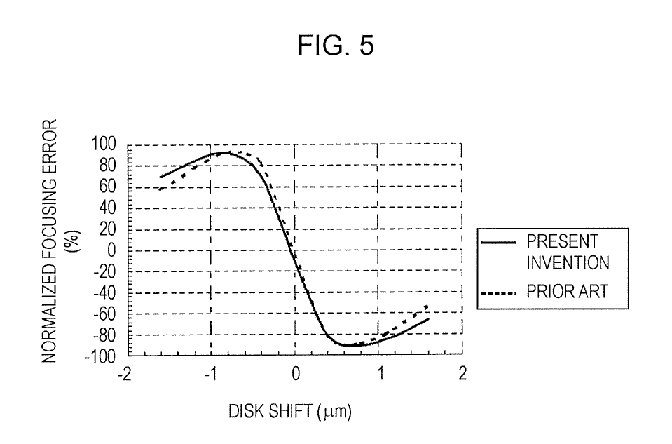

FIG. 5 illustrates focusing errors obtained when the disk shifts in a light axis direction (in a focusing direction).

The focusing error according to the present invention is indicated by a solid line, and the focusing error according to the known technology is indicated by a dotted line.

For evaluation of the focusing errors, FE is divided by (Sa+Sb+Sc+Sd) and normalized.

As clearly shown in the drawing, the focusing error according to the present invention is similar to that according to the known technology.

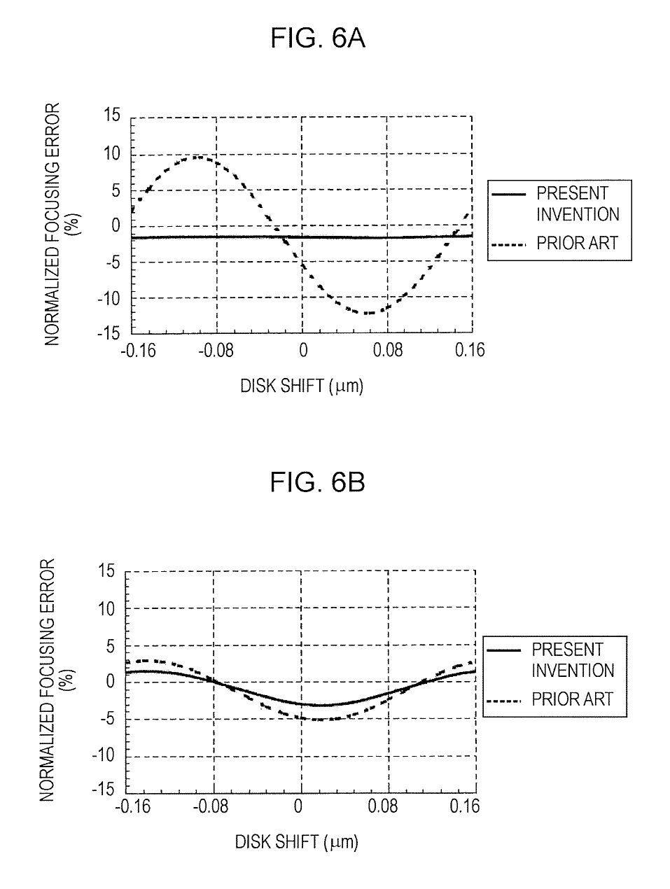

FIGS. 6A and 6B illustrate the focusing errors when the pregrooves move in a direction of the radius of the disk (in a direction perpendicular to the pregrooves) while only the focusing servo control is active. FIG. 6A illustrates a case when the photodetector is shifted relative to the spot (by an eighth of the radius of the spot 22), and FIG. 6B illustrates a case when astigmatism (0.4λ P-V) is introduced to an outward optical system. Moreover, the values of the focusing errors are normalized by the amplitude values thereof shown in FIG. 5 for evaluation.

The focusing errors according to the present invention are indicated by solid lines, and the focusing errors according to the known technology are indicated by dotted lines.

In FIG. 6A, the focusing error according to the known technology fluctuates due to the influence of the interference areas in connection with the movement of the pregrooves.

In contrast, the fluctuation of the focusing error according to the present invention is very small, and is maintained at about a tenth of that according to the known technology.

Moreover, in FIG. 6B, the focusing error according to the present invention is about a half of that according to the known technology.

As described above, it has been confirmed that the crosstalk of the components of the track-crossing signals into the focusing errors can be regulated.

### Second Exemplary Embodiment

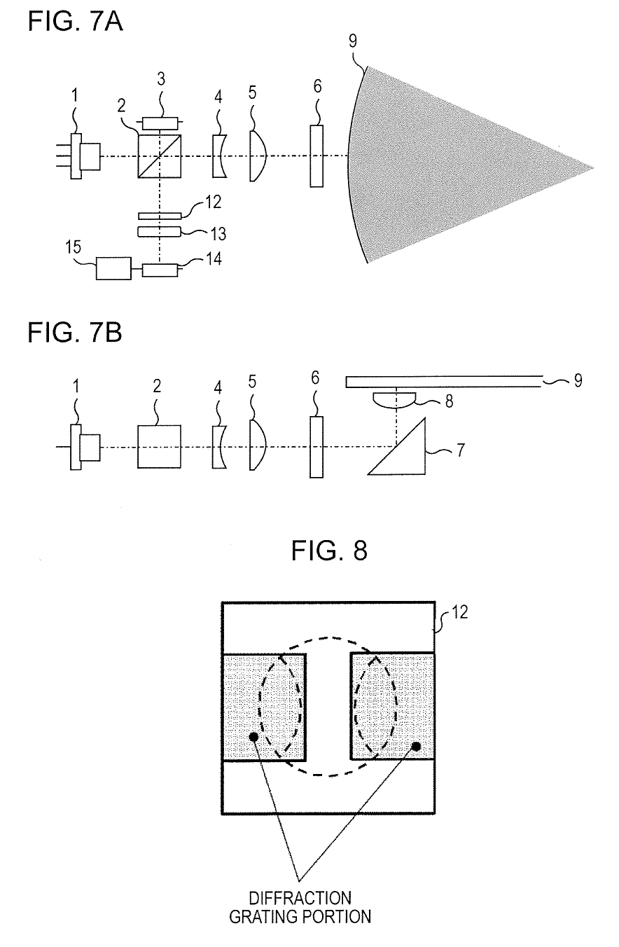

FIGS. 7A and 7B are schematic diagrams of an optical system of an apparatus for optically recording and reproducing information according to a second exemplary embodiment of the present invention.

The outward optical system from the LD 1 to the objective lens 8 is the same as that of the first exemplary embodiment.

An inward optical system will now be described. Light beams reflected from the optical disk 9 are incident on the PBS 2 via the objective lens 8, the quarter-wave plate 6, and the collimating lens unit including the first lens 4 and the second lens 5. These incident beams are reflected from the PBS 2, and are incident on a diffractive element 12 serving as a wavefront splitting element. The light beams passing through the diffractive element 12 are focused on a PD 14 for generating RF signals and servo control signals via a sensor lens 13. Information signals and servo control signals are obtained from the output from the PD 14 and can be supplied to the processor 15.

As schematically shown in FIG. 8, the diffractive element 12 includes diffraction grating portions that diffract light beams generated by the interference between the zeroth-order diffracted beams and the first-order diffracted beams. The diffraction grating portions are hatched in the drawing. Moreover, the diffraction grating portions are blazed such that the first-order diffracted beams are increased and diffracted beams other than the first-order diffracted beams are reduced.

Furthermore, the size of the diffraction grating portions is set such that the diffraction grating portions cover the interference areas of the spot and such that the interference areas do not protrude from the diffraction grating portions even when an assembly error (on the order of an eighth of the radius of the spot) is introduced.

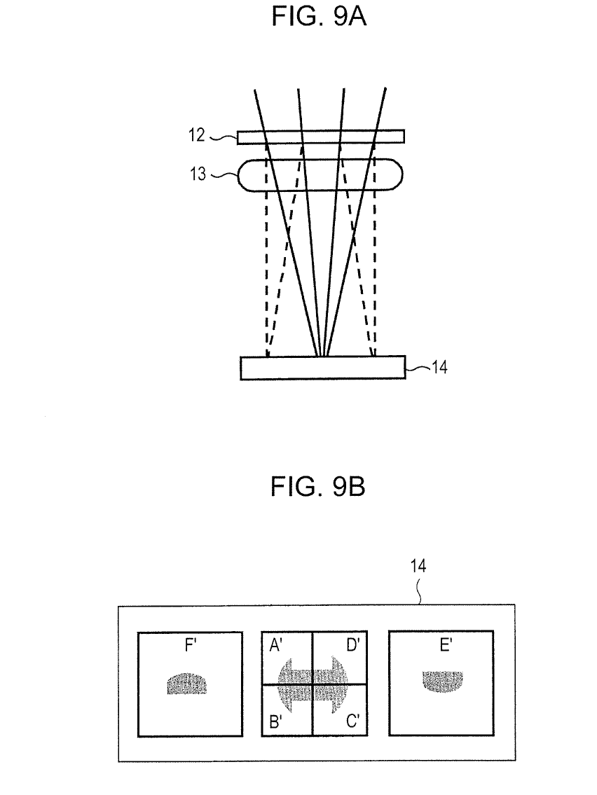

FIGS. 9A and 9B are schematic views of light detecting portions in the optical system and in the PD 14, respectively.

The PD 14 is a sextant photodetector including six sectioned regions A′, B′, C′, D′, E′, and F′.

As shown in FIG. 9A, light beams diffracted at the diffraction grating portions of the diffractive element 12 are incident on the regions E′ and F′ of the PD 14 via the sensor lens 13. Moreover, astigmatism is imparted to light beams that do not pass through the diffraction grating portions by the sensor lens 13, and the resultant beams are incident on the four regions A′, B′, C′, and D′. The sensor lens 13 is the same as the sensor lens 10 in the first exemplary embodiment.

Servo control signals are obtained from the following calculation:

FE=(Sa′+Sc′)−(Sb′+Sd′)

TE=Se′−Sf′

where Sa′, Sb′, Sc′, Sd′, Se′, and Sf′ indicate outputs from the regions A′, B′, C′, D′, E′, and F′, respectively.

In this manner, the effect of regulating the influence of the areas where the zeroth- and first-order diffracted beams interfere with each other during the generation of the focusing errors, which is equal to the effect in the first exemplary embodiment, can be accomplished.

As described above, the crosstalk of the components of the track-crossing signals into the focusing errors can be regulated.

Unstable focusing servo control, actuator noise, and the like are generated when, for example, astigmatism is introduced to the outward optical system due to relative displacement between the sensor and the spot caused by an assembly error, quality of the optical devices, or the like. However, such problems can also be reduced according to the present invention.

Moreover, in this exemplary embodiment, only the zeroth-order diffracted beams are used for generating the focusing error. However, the first-order diffracted beams can be superposed on the zeroth-order diffracted beams during the generation of the focusing error in so far as the focusing error signals are not significantly influenced.

According to the present invention, stable focusing errors can be obtained and actuator noise can be reduced by reducing the crosstalk of the components of the track-crossing signals into the focusing errors.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the priority of Japanese Application No. 2006-027120 filed Feb. 3, 2006, which is hereby incorporated by reference herein in its entirety.

What is claimed is:

1. An apparatus for optically reproducing and recording information comprising:
a light source;
an objective lens that focuses light beams emitted from the light source on an optical recording medium having tracks disposed at a track pitch, wherein the wavelength of the light beams emitted from the light source is greater than the track pitch of the optical recording medium;
a light detecting element that receives light beams reflected from the optical recording medium, wherein the light detecting element includes a first region that receives substantially only light beams generated by interference between zeroth-order diffracted beams and first-order diffracted beams among the light beams reflected from the tracks of the optical recording medium and a second region that receives substantially only the zeroth-order diffracted beams; and
a processor that generates focusing error signals using astigmatic focusing error detection on the basis of an output from the second region of the light detecting element.

2. An apparatus according to claim 1, wherein the light detecting element includes six sections, with the first region including two sections and the second region including four sections.

3. An apparatus according to claim 1, wherein the area of the first region is less than the area of the second region of the light detecting element.

4. An apparatus according to claim 1, wherein at least a portion of the first region is disposed closer than the second region to a center of the light detecting element.

5. An apparatus for optically reproducing and recording information comprising:
a light source;
an objective lens that focuses light beams emitted from the light source on an optical recording medium having tracks disposed at a track pitch, wherein the wavelength of the light beams emitted from the light source is greater than the track pitch of the optical recording medium;
a wavefront splitting element that splits light beams reflected from the optical recording medium, wherein the wavefront splitting element includes a first region that receives mainly light beams generated by interference between zeroth-order diffracted beams and first-order diffracted beams among the light beams reflected from the tracks of the optical recording medium and a second region that receives substantially only the zeroth-order diffracted beams;
a light detecting element that receives light beams passing through the wavefront splitting element; and
a processor that generates focusing error signals using astigmatic focusing error detection on the basis of an output from the light detecting element that receives the light beams passing through the second region of the wavefront splitting element.

6. An apparatus according to claim 5, wherein the first region of the wavefront splitting element includes a diffraction grating.

7. An apparatus according to claim 5, wherein the first region of the wavefront splitting element includes two sections.

8. An apparatus according to claim 5, wherein at least a portion of the first region is disposed closer than the second region to a center of the wavefront splitting element.

9. An apparatus for optically reproducing and recording information comprising:
a light source;
focusing means for focusing light beams emitted from the light source on an optical recording medium having tracks disposed at a track pitch, wherein the wavelength of the light beams emitted from the light source is greater than the track pitch of the optical recording medium;
receiving means for receiving light beams reflected from the optical recording medium, wherein the receiving means includes a first region for receiving substantially only light beams generated by interference between zeroth-order diffracted beams and first-order diffracted beams among the light beams reflected from the tracks of the optical recording medium and a second region for receiving substantially only the zeroth-order diffracted beams; and
generating means for generating focusing error signals using astigmatic focusing error detection on the basis of an output from the second region of said receiving means.

10. An apparatus according to claim 9, wherein the receiving means comprises a light detecting element.

11. An apparatus according to claim 9, wherein the receiving means comprises a light detecting element and a wavefront splitting element.
